(19) United States
(12) Patent Application Publication
(10) Pub. No.: US 2002/0037752 A1
(43) Pub. Date: Mar. 28, 2002

(54) Mobile radio communication apparatus

(76) Inventor: Yoshiharu Asaoka, Hino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/956,012

(22) Filed: Sep. 20, 2001

(30) Foreign Application Priority Data
Sep. 26, 2000 (JP) 2000-291807

(51) Int. Cl. H04M 1/00

(52) U.S. Cl. 455/566; 455/567

(57) ABSTRACT

A mobile radio communication apparatus includes a liquid crystal display section configured to display information, keys configured to input information, a first illuminating section configured to illuminate the liquid crystal display section, and a second illuminating section configured to illuminate the keys. The apparatus further includes a detecting section configured to detect a predetermined operation of the apparatus, and a control section configured to operate the first illuminating section to illuminate the liquid crystal display section and not to operate the second illuminating section so as not to illuminate the keys, when the detecting section detects the predetermined operation of the apparatus. This makes it possible to provide a mobile radio communication apparatus capable of reducing the current consumption and permitting a user to reliably check information displayed on the LCD screen.

### CROSS-REFERENCE TO RELATED APPLICATIONS

This application is based upon and claims the benefit of priority from the prior Japanese Patent Application No. 2000-291807, filed Sep. 26, 2000, the entire contents of which are incorporated herein by reference.

### BACKGROUND OF THE INVENTION

1. Field of the Invention The present invention relates to a mobile radio communication apparatus including an improved control circuit for controlling a back light for illuminating input keys and a display screen attached to the mobile radio communication apparatus.

2. Description of the Related Art

A mobile ratio communication apparatus generally has a function of controlling back lights for illuminating, on the basis of key input, keys and an LCD (Liquid Crystal Display) from behind for a predetermined time since the key input timing. One purpose of this back light control function is to enable key input in a dark place.

On the other hand, assuming that, e.g., a user often uses the mobile radio communication apparatus in bright places and wishes power saving, the back lights can be turned off by a user.

In this conventional mobile radio communication apparatus, however, if the user turns off the back lights, both the LCD back light and the key back light are turned off. That is, the LCD back light and the key back light are synchronized.

In the conventional mobile radio communication apparatus, power saving is accomplished when the back lights are turned off. However, a user cannot easily check the displayed contents on the LCD screen with the back lights turned off especially when the LCD is a color display.

As described above, in the conventional mobile radio communication apparatus, the LCD and key illumination control operations are synchronized. This makes it impossible to satisfy power saving and the ease with which the LCD screen is viewed at the same time.

### BRIEF SUMMARY OF THE INVENTION

It is, therefore, an object of the present invention to provide a mobile radio communication apparatus by which the current consumption can be reduced and the display on an LCD screen can be reliably viewed.

According to a first aspect of the present invention, there is provided a mobile radio communication apparatus comprising

a liquid crystal display configured to display information,

keys configured to input information,

a first illuminating section configured to illuminate the liquid crystal display,

a second illuminating section configured to illuminate the keys,

a detector configured to detect a predetermined operation of the apparatus, and

a controller configured to operate the first illuminating section to illuminate the liquid crystal display and not to operate the second illuminating section so as not to illuminate the keys, when the detector detects the predetermined operation of the apparatus.

According to a second aspect of the present invention, there is provided a mobile radio communication apparatus comprising

a liquid crystal display configured to display information;

keys configured to input information;

a first illuminating section configured to illuminate the liquid crystal display;

a second illuminating section configured to illuminate the keys;

a detector configured to detect a predetermined operation of the apparatus; and

a controller configured to operate the first illuminating section to illuminate the liquid crystal display for a first time period and operate the second illuminating section to illuminate the keys for a second time period shorter than the first time period, when the detector detects the predetermined operation of the apparatus.

According to a third aspect of the present invention, there is provided a mobile radio communication apparatus comprising

a liquid crystal display configured to display information

keys configured to input information,

a first illuminating section configured to illuminate the liquid crystal display,

a second illuminating section configured to illuminate the keys, comprising:

a detector configured to detect a predetermined operation of the apparatus; and

a controller configured to perform control such that the first illuminating section illuminates the liquid crystal display for a first time period and the second illuminating section illuminates the keys for a second time period shorter than the first time period, when the detector detects the predetermined operation of the apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram showing a mobile radio communication apparatus according to the first and second embodiments of the present invention;

FIG. 2 is a view for explaining choices when the ON/OFF states of an LCD back light LED and a key back light LED shown in FIG. 1 are set;

FIG. 3 is a flow chart showing a method of controlling the ON/OFF states of the LCD back light LED and the key back light LED shown in FIG. 1;

FIG. 4 is a flow chart showing another method of controlling the ON/OFF states of the LCD back light LED and the key back light LED shown in FIG. 1;

FIG. 5 is a view for explaining choices when the lighting-up times of an LCD back light LED and a key back light LED shown in FIG. 1 are set according to the second embodiment of the present invention;

FIG. 6 is a flow chart showing a method of controlling the ON/OFF states of an LCD back light LED and a key back light LED according to the second embodiment of the present invention; and

FIG. 7 is a flow chart showing another method of controlling the ON/OFF states of the LCD back light LED and the key back light LED shown in FIG. 1 according to the second embodiment of the present invention.

### DETAILED DESCRIPTION OF THE INVENTION

Embodiments of a mobile radio communication apparatus of the present invention will be described below with reference to the accompanying drawings.

(First Embodiment)

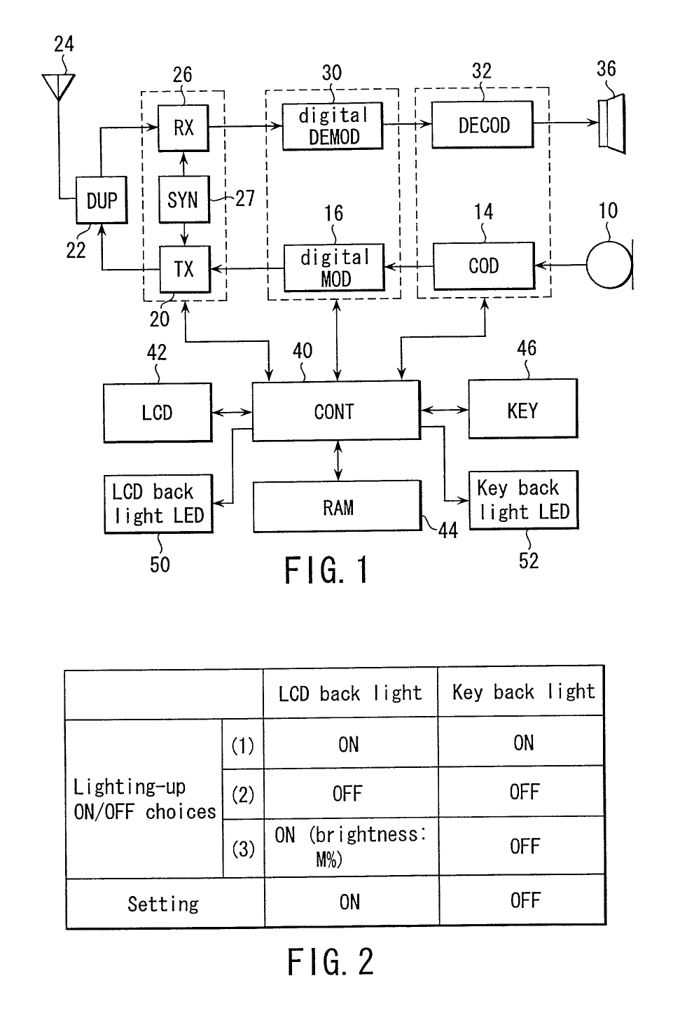

The first embodiment of the present invention will be explained below. FIG. 1 is a block diagram showing the configuration of a mobile radio communication apparatus according to this embodiment.

Referring to FIG. 1, a transmitted voice signal output from a microphone 10 is digitized and compressed by an encoder 14. The compressed signal is digitally modulated by a digital modulator 16. A radio transmitting section 20 converts the modulated signal into a high-frequency signal in accordance with a local signal output from a synthesizer 27. The high-frequency signal is raised to a predetermined power level and supplied only to an antenna 24 by a duplexer 22. The supplied signal is transmitted as a radio high-frequency signal via the antenna 24.

On the other hand, a radio high-frequency signal received from a base station by the antenna 24 is supplied from the duplexer 22 to only a radio receiving section 26. The radio receiving section 26 amplifies the received high-frequency signal and converts the amplified signal into a baseband (low-frequency band) signal together with a local signal from the synthesizer 27. The converted signal is input to a digital demodulating section 30 and digitally demodulated.

A decoder 32 decodes the demodulated signal into an audio signal, decompresses the audio signal, and converts the decompressed signal into an analog signal. The analog signal is output from a loudspeaker 36.

A control section 40 is connected to an LCD 42 as a display section, a RAM 44, and keys 46 as an input operation section. The LCD 42 and the keys 46 are used for voice call input and display, and also used for character input. An LCD back light LED (Light-Emitting Diode) 50 for illuminating the LCD 42 screen 42 and a key back light LED 52 for illuminating the keys 46 are also connected to and controlled by the control section 40.

In this embodiment, the back light lighting-up time of the LCD 42 as a display section and the back light lighting-up time of the input keys in the input operation section 46 can be separately set.

With this setting, when a certain operation of the mobile radio communication apparatus such as a key input or an incoming call is detected, the LCD back light LED 50 can be turned on while the input key back light LED 52 is kept off. Accordingly, the LCD screen 42 is kept readily viewable while the current consumption is suppressed. Especially when the LCD 42 is a color display or a moving picture is displayed, it is important to turn on the back light to make the LCD screen 42 easy to see.

Back light lighting-up setting will be explained with reference to FIG. 2. Choice (1) by which both the LCD back light LED 50 and the key back light LED 52 are ON and choice (2) by which both are OFF are the same as in the conventional apparatus. The present invention is characterized in that the LCD back light LED 50 and the key back light LED 52 can be set to ON and OFF, respectively, as choice (3). A user can also set the brightness level of the LCD back light LED 50. That is, a user can adjust the brightness level by using predetermined keys of the keys 46. For example, the brightness level is set to M% (M is a number larger than 0) desired by a user. By this brightness level adjustment, a brightness level with which the user can view the LCD 42 most easily can be set. When the brightness level is less than 100%, display power can be saved, i.e., power saving is achieved.

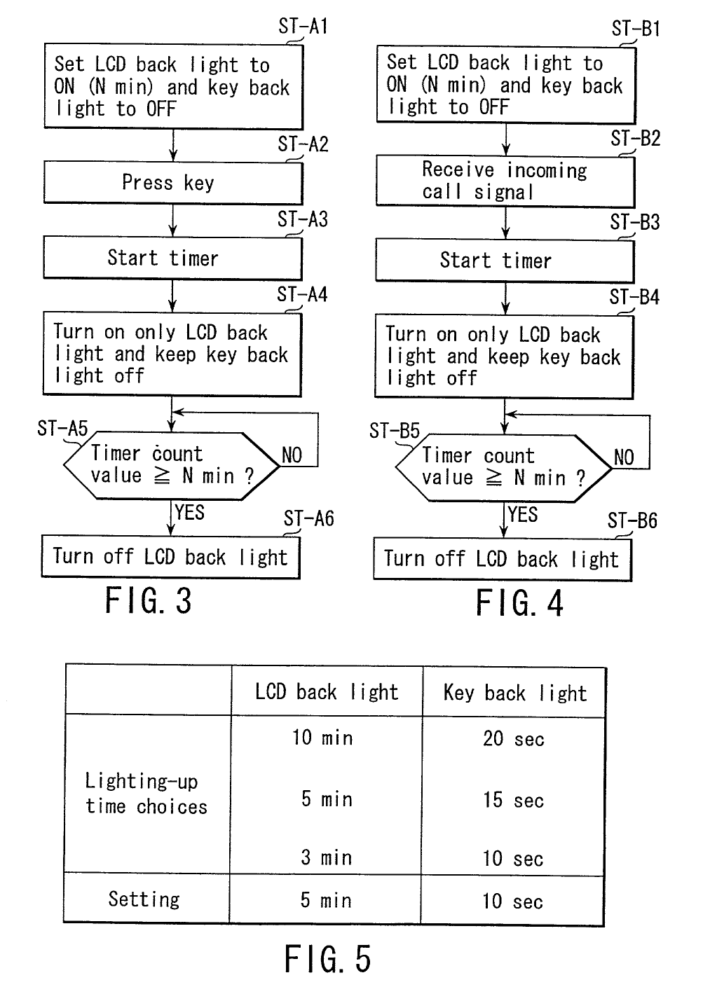

A flow showing the operation when this setting is done will be described below with reference to FIG. 3. In step ST-A1, the LCD back light LED 50 is set to ON and the key back light LED 52 is set to OFF. The ON time of the LCD back light LED 50 is predetermined to N (N is a natural number; N=1, 2, 3, . . . ). This ON time can also be set in sections of seconds, not in sections of minutes.

After this time setting, the user presses a certain key of the keys 46 (step ST-A2). After that, an internal timer of the control section 40 is started (step ST-A3).

The LCD back light LED 50 is turned on, and the key back light LED 52 is kept off (step ST-A4). When the timer count value reaches N min (step ST-A5), the LCD back light LED 50 is turned off (step ST-A6). Until the timer count value reaches N min, whether the timer count value has reached N min is repetitively checked at a constant interval in step ST-A5.

With this control, the key back light LED 52 can be kept off when the user performs key input, so a power saving effect is obtained. Along with this power saving effect, the ease with which the LCD screen 42 is viewed can be ensured because the LCD back light LED 50 is ON. Especially when the LCD screen 42 displays a color image and the user views this display, controlling the LCD back light LED 50 to ON is effective.

In this embodiment, back light control is performed on the basis of key input. However, this control can also be performed on the basis of detection of another operation. For example, the above back light control can be performed when it is detected that the mobile radio communication apparatus has received an incoming call signal. FIG. 4 shows a flow chart of this control. Referring to FIG. 4, only step ST-A2 shown in FIG. 3 is changed. That is, the timer starts when the mobile radio communication apparatus has received an incoming call signal, not when a user presses a certain key of the keys 46 (step ST-B2). Other steps ST-B1 and ST-B3 to ST-B6 are similar to ST-A1 and ST-A3 to ST-A6.

In the mobile radio communication apparatus according to the first embodiment of the present invention as described above, when a predetermined operation of this mobile radio communication apparatus is detected, a first illuminating section is operated to illuminate a liquid crystal display section, and a second illuminating section is not operated so as not to illuminate keys 46.

(Second Embodiment) The second embodiment is characterized in that ON times of an LCD back light and a key back light can be separately set in choice (1) by which both the LCD back light and the key back light are turned on. The choice (1) is one of the three setting patterns shown in FIG. 2 of the first embodiment.

As shown in FIG. 5, a user can set the lighting-up time of an LCD back light LED 50 and the lighting-up time of a key back light LED 52. The lighting-up time of the LCD back light LED 50 can be set to 10, 5, or 3 min. The lighting-up time of the key back light LED 52 can be set to 20, 15, or 10 sec. Regardless of the set lighting-up times, the lighting-up time of the LCD back light LED 50 is longer than that of the key back light LED 52.

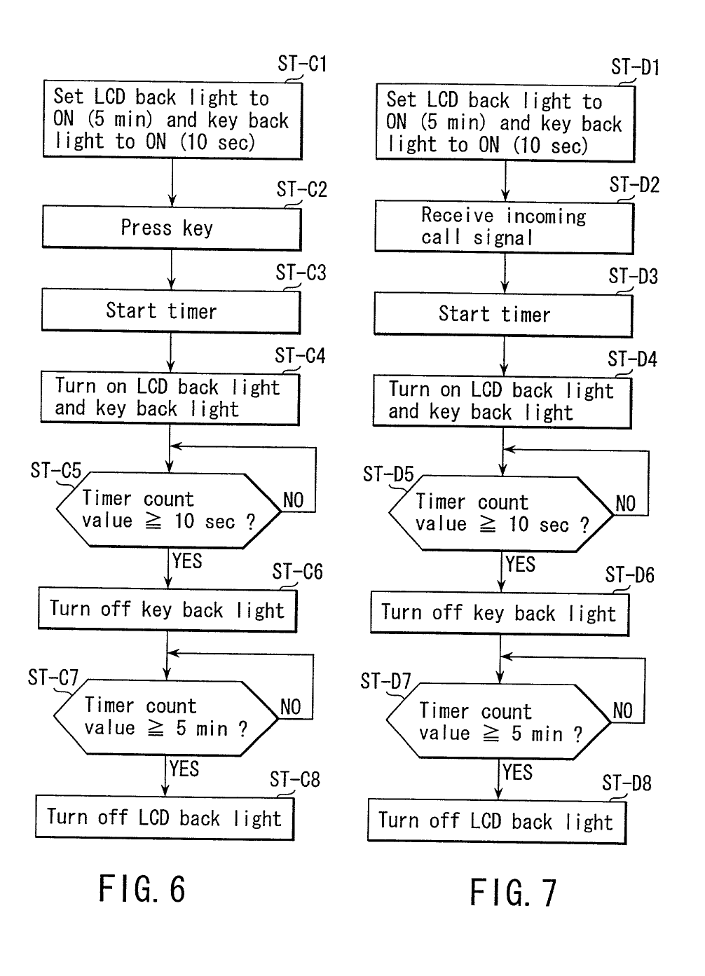

The operation of controlling the back light LEDS 50 and 52 when the user sets 5 min as the lighting-up time of the LCD back light LED 50 and 10 sec as the lighting-up time of the key back light LED 52 will be explained below with reference to FIG. 6.

When the above setting is done in step ST-C1, the user presses a certain key of keys 46 (step ST-C2), and a timer starts (step ST-C3).

At the same time the timer starts in step ST-C3, both the LCD and key back light LEDs 50 and 52 are turned on (step ST-C4). Whether the timer count value has reached 10 sec is checked (step ST-C5). If the timer count value is 10 sec, the key back light LED 52 is turned off (step ST-C6). If the timer count value is less than 10 sec, whether the timer count value has reached 10 sec is repetitively checked at a predetermined interval in step ST-C5.

Next, whether the timer count value has reached 5 min is checked (step ST-C7). If the timer count value is 5 min, the LCD back light LED 50 is turned off (step ST-C8). If the timer count value is less than 5 min, whether the timer count value has reached 5 min is repetitively checked at a predetermined interval in step ST-C5.

As described above, since the lighting-up time of the LCD screen back light LED 50 and the lighting-up time of the key back light LED 52 can be set, a power saving effect can be obtained. In addition, the lighting-up time of the LCD screen back light LED 50 and the lighting-up time of the key back light LED 52 can be independently set, and the LCD screen back light LED 50 is kept on for a longer time period than the lighting-up time of the key back light LED 52. Therefore, the lighting-up time can be so set as to allow the user to view the LCD screen 42 with no problem.

In the above embodiment, the ON/OFF states of the back light LEDs are controlled on the basis of key input. However, this control can also be performed on the basis of detection of another operation. For example, the above back light LED ON/OFF states can be controlled when it is detected that the mobile radio communication apparatus has received an incoming call signal. FIG. 7 shows a flow chart of this control. Referring to FIG. 7, only step ST-C2 shown in FIG. 6 is changed. That is, the timer starts when the mobile radio communication apparatus has received an incoming call signal (step ST-D2), not when a user presses a certain key of the keys 46. Other steps ST-D1 and ST-D3 to ST-D6 are similar to ST-Cl and ST-C3 to ST-C6.

In the mobile radio communication apparatus according to the second embodiment of the present invention as described above, when a predetermined operation of this mobile radio communication apparatus is detected, a first illuminating section is operated to illuminate a liquid crystal display section for a first time period, and a second illuminating section is operated to illuminate keys 46 for a second time period shorter than the first time period.

The above first and second embodiments have been explained by taking back light LEDs for illuminating an LCD 42 and keys 46 from behind as examples. However, the present invention is not limited to these embodiments and is applicable to any structure which illuminates an LCD 42 or keys 46, e.g., a structure which illuminates an LCD 42 or keys 46 sideways.

Also, each embodiment has the effect of reducing the current consumption required for illumination of the mobile radio communication apparatus and permitting a user to reliably check information displayed on the liquid crystal display.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio communication apparatus comprising:
a liquid crystal display configured to display information;
keys configured to input information;
a first illuminating section configured to illuminate said liquid crystal display;
a second illuminating section configured to illuminate said keys;
a detector configured to detect a predetermined operation of said apparatus; and
a controller configured to operate said first illuminating section to illuminate said liquid crystal display and not to operate said second illuminating section so as not to illuminate said keys, when said detector detects the predetermined operation of said apparatus.

2. The apparatus according to claim 1, wherein said liquid crystal display has color capability.

3. The apparatus according to claim 1, wherein the predetermined operation of said apparatus is an operation of detecting an operation of any of said keys.

4. The apparatus according to claim 1, wherein the predetermined operation is an operation of receiving an incoming call signal.

5. The apparatus according to claim 1, further comprising a brightness level setting section configured to set a brightness level of said first illuminating section.

6. A mobile radio communication apparatus comprising:
a liquid crystal display configured to display information;
keys configured to input information;
a first illuminating section configured to illuminate said liquid crystal display;
a second illuminating section configured to illuminate said keys;
a detector configured to detect a predetermined operation of said apparatus; and
a controller configured to operate said first illuminating section to illuminate said liquid crystal display for a first time period and operate said second illuminating section to illuminate said keys for a second time period shorter than the first time period, when said detector detects the predetermined operation of said apparatus.

7. The apparatus according to claim 6, further comprising a setting section configured to set the first and second time periods such that the second time period is shorter than the first time period.

8. The apparatus according to claim 6, wherein said liquid crystal display has color capability.

9. The apparatus according to claim 6, wherein the predetermined operation of said apparatus is an operation of detecting an operation of any of said keys.

10. The apparatus according to claim 6, wherein the predetermined operation is an operation of receiving an incoming call signal.

11. The apparatus according to claim 6, further comprising a brightness level setting section configured to set a brightness level of said first illuminating section.

12. A mobile radio communication apparatus comprising:
a liquid crystal display configured to display information
keys configured to input information,
a first illuminating section configured to illuminate said liquid crystal display,
a second illuminating section configured to illuminate said keys, comprising:
a detector configured to detect a predetermined operation of said apparatus; and
a controller configured to perform control such that said first illuminating section illuminates said liquid crystal display for a first time period and said second illuminating section illuminates said keys for a second time period shorter than the first time period, when said detector detects the predetermined operation of said apparatus.

13. The apparatus according to claim 12, further comprising a setting section configured to set the first and second time periods such that the second time period is shorter than the first time period.

14. The apparatus according to claim 12, wherein said liquid crystal display has color capability.

15. The apparatus according to claim 12, wherein the predetermined operation of said apparatus is an operation of detecting an operation of any of said keys.

16. The apparatus according to claim 12, wherein the predetermined operation is an operation of receiving an incoming call signal.

17. The apparatus according to claim 12, further comprising a brightness level setting section configured to set a brightness level of said first illuminating section.
